(19) United States
(12) Patent Application Publication
(10) Pub. No.: US 2024/0292807 A1
(43) Pub. Date: Sep. 5, 2024

(54) Animal Traction Mat

(71) Applicant: Carol Beuchat, Mission Viejo, CA (US)

(72) Inventor: Carol Beuchat, Mission Viejo, CA (US)

(21) Appl. No.: 18/575,523

(22) PCT Filed: Jun. 29, 2022
(86) PCT No.: PCT/US2022/035517

§ 371 Date: Dec. 29, 2023

Related U.S. Application Data
(60) Provisional application No. 63/216,669, filed on Jun. 30, 2021.

(51) Int. Cl. A01K 1/015

(52) U.S. Cl. CPC A01K 1/0157

(57) ABSTRACT

A traction mat comprising a non-uniform horizontal surface for the foot of an animal to push against. A plurality of holes are defined in the mat, at least one of the plurality of holes being sized to accommodate the diameter of at least one foot of the animal. When the animal attempts to move forward, its foot is pushed backwards against the substrate of the mat and engages with the vertical wall of at least one hole, allowing the animal to push itself forward. As the animal traverses across the surface of the mat, the animal continues to push against the inner vertical walls of corresponding holes it comes into contact with. When provided a surface to push against, the extension-adduction movement that damages the teres ligament does not occur. By preventing the development of laxity due to ligament damage, the risk of CHD should be reduced.

This application claims priority to, and the benefit of the earlier filing date of US provisional patent application entitled “Animal Traction Mat”, filed on Jun. 30, 2021, Ser. No. 63/216,669, pursuant to 35 USC 119, the contents of all of which are incorporated herein by reference.

### BACKGROUND

### Field of the Technology

The invention relates to the field of veterinary medicine, specifically the prevention and treatment of orthopedic maladies or conditions in animals, specifically in extremely young or juvenile canines and other animals.

### Description of the Prior Art

Canines are susceptible to many orthopedic disorders, some of which are described as “developmental.” These various disorders are not present at birth, but rather develop over the growth period of the canine. Some of these orthopedic disorders can become apparent while the canine is still a newborn or relatively young, while other disorders may only produce symptoms after the canine is older.

Canine hip dysplasia (CHD) is a developmental disorder that is common in canines. In this disease, the development of the hip joint (socket and head of the femur) is abnormal. The socket can be shallower than normal and the edges of the rim of the socket can be damaged. The shallow socket, together with the damage to the rim, produces a socket that is “loose,” namely the head of the femur does not fit tightly into a deep socket, but rather there can be subluxation (displacement of the head of the femur from its normal position in the socket). Subluxation produces abnormal forces on the hip socket, and through bone remodeling results in the structural characteristics of hip dysplasia.

CHD is thought to be the result of both genetic and “environmental” (i.e., non-genetic) factors. In some breeds, the majority of individuals demonstrate some dysplasia of the hip joint, while in other breeds the disorder is rare. Likewise, CHD can be more common in some family lines of a breed than in others. These differences in CHD frequency and distribution are thought to reflect the effects of genetics on the risk and expression of the disorder.

Because of the apparent involvement of genetics in CHD, breeders have tried to reduce the incidence of the disease through selective breeding; i.e., preferential breeding of canines with hips that are normal or that display milder signs of CHD, and selection against canines with more severe dysplasia. Breeders evaluate the soundness of the hip through procedures that either visualize the structure (e.g., x-ray) or quantify parameters of the socket thought to reflect the laxity of the hip and therefore the risk of developing CHD.

Laxity, or looseness, in the joint can be the result of damage to the teres ligament, which originates on the wall of the acetabulum and inserts on the head of the femur. This ligament is very short and strong in the newborn puppy, and it gradually lengthens as the puppy matures. Damage to this ligament can result in premature elongation and greater laxity in the joint.

In humans, hip dysplasia can be the result of laxity in the hip joint that results from forceful extension and adduction of the legs. This puts strain on the teres ligament as the head of the femur is pulled away from the hip socket. This extension-adduction position can occur when babies are swaddled tightly instead of leaving space for the abduction and flexion of the legs.

Damage to the teres ligament has been noted in canines that are only 4 weeks old, and in some instances at only 2 weeks. Extremely young canines like puppies do little more than nurse and sleep for the first two weeks of life (eyes usually open at 10 days), so the opportunities to damage the ligament are very limited. Forceful extension and adduction of the back legs occurs in puppies when they attempt to move forward on a substrate with inadequate traction. The bottom of the foot pad of a young canine is very smooth, so the foot slips over the substrate whenever the puppy tries to move itself forward by pushing horizontally against a horizontal surface. This movement can be repeated continuously while the puppy is nursing as it attempts to push forward to reach the teat of the mother to nurse and also when moving around the whelping box. This could be responsible for the ligament damage that was observed in puppies only weeks old. Thus, inadequate traction in the whelping box is a risk factor for the development of laxity in the hip joint that can result in hip dysplasia.

Typically, means for adding traction and padding currently for puppies and other young or juvenile canines includes soft pads made of suede, terry cloth, or other blends of fabric which are placed on the bottom surface of a kennel, crate, or whelping box. Any puppies within the kennel or whelping box are then allowed to crawl on top of the pad while nursing, playing, or otherwise exploring their immediate surroundings. However, due to the slick, smooth, or otherwise highly deformable material comprising the pad and the relative smoothness of the paws of the puppy, the puppy cannot achieve much traction and thus has great difficultly any time the puppy attempts to traverse across the pad. The result then is that the puppy is forced to “swim” across the pad, namely repeatedly extend their back legs and fore legs in an attempt to move across the pad. It is this repeated hyperextension of the joints which can lead to tearing of the teres ligament which in turn can lead to laxity in the joint and eventually to canine hip dysplasia (CHD).

What is needed is a means for providing adequate traction for canines, particularly young canines and puppies. The means should also preferably provide sufficient traction for different types of breeds of canines or for a variety of canines which are at different stages of development or growth. Additionally, the means should be easy to use and implement as well as sufficiently durable so as to be used for prolonged periods of time. Furthermore the means should be adaptable for other domestic and captive wild animals, for example for animals contained within a zoo, animal sanctuary, or other facility.

### BRIEF SUMMARY

The current invention solves this problem and others by providing a non-horizontal surface for the foot of the puppy to push against. This is accomplished by an array of holes defined in a mat of appropriate thickness that are sized to accommodate the diameter of the back foot of puppies from birth to about 3 weeks old. When the puppy attempts to move forward, the foot is pushed backwards against the substrate of the mat. When it engages the vertical wall of a hole, the puppy can then push itself forward. Similarly, the puppy's front legs and feet also push against the vertical surfaces provided by the holes in the same manner. When provided a surface to push against, the extension-adduction movement that damages the teres ligament does not occur. By preventing the development of laxity due to ligament damage, the risk of CHD should be reduced.

The current invention provides a traction mat for preventing or treating developmental disorders in an animal. The traction mat includes a first surface with a plurality of holes symmetrically defined across the first surface. Each of the plurality of holes have a continuous smooth inner vertical wall that is defined through a height of the traction mat.

In one embodiment, the plurality of holes that are symmetrically defined across the first surface include a first plurality of holes that have a first diameter that are symmetrically defined across the first surface and a second plurality of holes that have a corresponding second diameter which are also symmetrically defined across the first surface. Here, the first diameter of the first plurality of holes is larger than the second diameter of the second plurality of holes.

In another embodiment, the plurality of holes that are symmetrically defined across the first surface include a first plurality of holes that have a first diameter symmetrically defined across the first surface, a second plurality of holes that have a second diameter symmetrically defined across the first surface, and a third plurality of holes having a third diameter symmetrically defined across the first surface. Here, second diameter of the second plurality of holes is preferably smaller than the first diameter of the first plurality of holes but larger than the third diameter of the third plurality of holes. More specifically, the first diameter corresponding to the first plurality of holes is at least three times larger than the third diameter of the third plurality of holes. In a related embodiment, the second diameter corresponding to the second plurality of holes is at least two times larger than the third diameter corresponding to the third plurality of holes.

In a different embodiment, the surface of the traction mat further includes a frame portion that surrounds or is disposed around the plurality of holes.

In yet another embodiment, the traction mat also includes a second surface and a plurality of holes that are symmetrically defined across the second surface. Each of the plurality of holes defined across the second surface have a continuous smooth inner vertical wall that are defined through at least a portion of the height of the traction mat. Specifically, at least one of the plurality of holes defined across the second surface is disposed within at least one of the plurality of holes defined across the first surface.

The current invention further provides a kit for preventing or treating developmental disorders in an animal. The kit includes a first traction mat as discussed above along with a second traction mat. Both the first traction mat and the second traction mat each have a plurality of holes defined through their respective surfaces.

In one embodiment, the first traction mat comprises a thickness that is different relative to a thickness of the second traction mat.

In another embodiment, the plurality of holes defined through the surface of the first traction mat have a diameter which is different relative to a diameter of the plurality of holes defined through the surface of the second traction mat.

In a further embodiment, the plurality of holes that are defined through the surface of the first traction mat are specifically disposed in a pattern across the surface of the first traction mat which is different relative to the plurality of holes that are defined through the surface of the second traction mat.

In one embodiment, the kit also includes a third traction mat, where the third traction mat itself has a plurality of holes that are defined through its respective surface.

The current invention also provides a method of manufacturing a traction mat as discussed above for an animal. The method includes providing the traction mat with a thickness and then defining a plurality of holes through the thickness of the traction mat, where each of the plurality of holes comprises a diameter. The thickness of the traction mat and the diameter of each of the plurality holes are specifically dependent upon a width of a foot of the animal.

In one embodiment, providing the traction mat with a thickness specifically includes providing the traction mat with a thickness which is between 20% and 50% the width of the foot of the animal.

In another embodiment, defining the plurality of holes through the thickness of the traction mat more specifically includes providing a continuous smooth inner surface within the traction mat for each of the plurality of holes.

In a related embodiment, defining the plurality of holes through the thickness of the traction mat further includes determining a spacing between each of the plurality of holes that are defined through the thickness of the traction mat which is dependent upon a length of a leg of the animal. More specifically, determining the spacing between each of the plurality of holes defined through the thickness of the traction mat includes defining each of the plurality of holes at a distance not more than 75% of the length of the leg of the animal from any other of the plurality of holes.

In yet a further embodiment, defining the plurality of holes through the thickness of the traction mat includes defining a first plurality of holes through the thickness of the traction mat with a first diameter, defining a second plurality of holes through the thickness of the traction mat with a second diameter, and defining a third plurality of holes through the thickness of the traction mat with a third diameter. The first diameter, second diameter, and third diameter are each dependent upon the width of the foot of the animal. More specifically, the first diameter is at most 75% longer than a length of a leg of the animal, where the second diameter is at least two times as long as the first diameter, and where the third diameter is at least three times as long as the first diameter.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

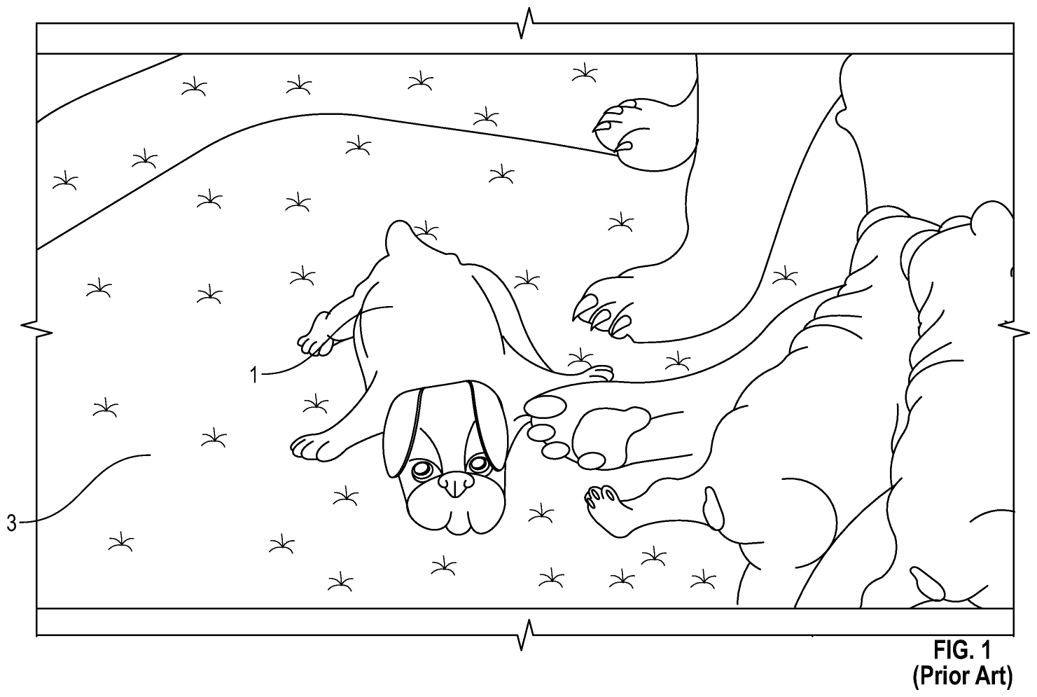

FIG. 1 depicts the current state of the art with regard to traction means and padding currently used for puppies and other young or juvenile canines. Currently, soft pads 3 made of suede, terry cloth, or other blends of fabric are placed on the bottom surface of a kennel, crate, or whelping box. Any puppies 1 contained within the kennel or whelping box are then allowed to crawl on top of the pad 3 while nursing, playing, or otherwise exploring their immediate surroundings. However, due to the slick, smooth, or otherwise highly deformable material comprising the pad 3 and the relative smoothness of the paws of the puppy 1, the puppy 1 cannot achieve much traction and thus has great difficultly any time the puppy 1 attempts to traverse across the pad 3. The result then, as seen in FIG. 1, is that the puppy 1 is forced to “swim” across the pad 3, namely by repeatedly extending their back legs and fore legs in an attempt to move across the pad 3. It is this repeated hyperextension of the joints which can lead to tearing of the teres ligament which in turn can lead to laxity in the joint and eventually to CHD.

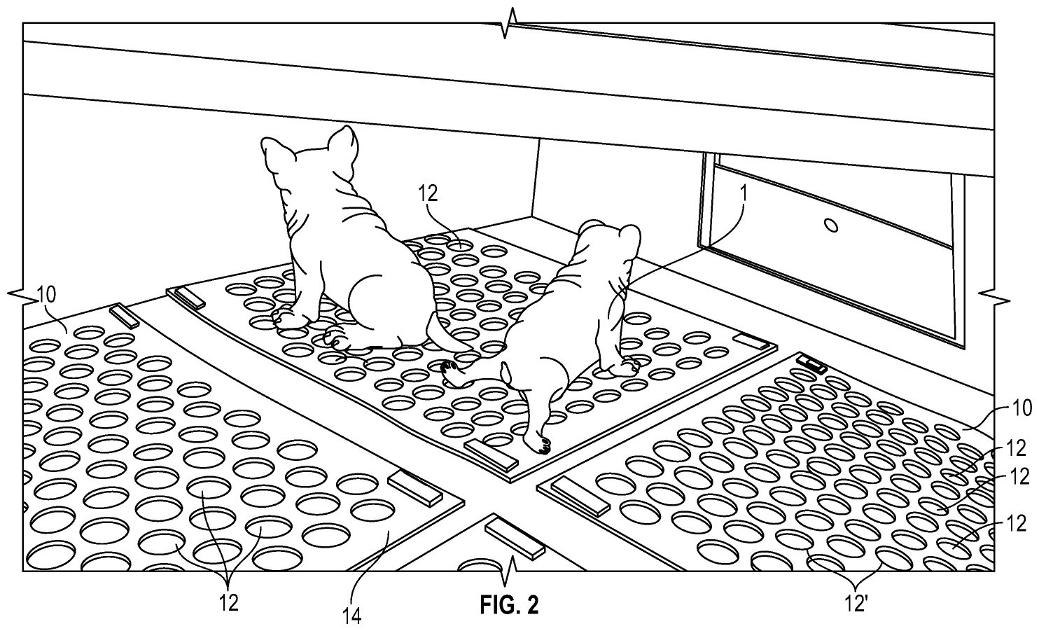

Greater detail of the current invention may be had by turning to FIGS. 2-8C where the traction mat is denoted generally by reference numeral 10.

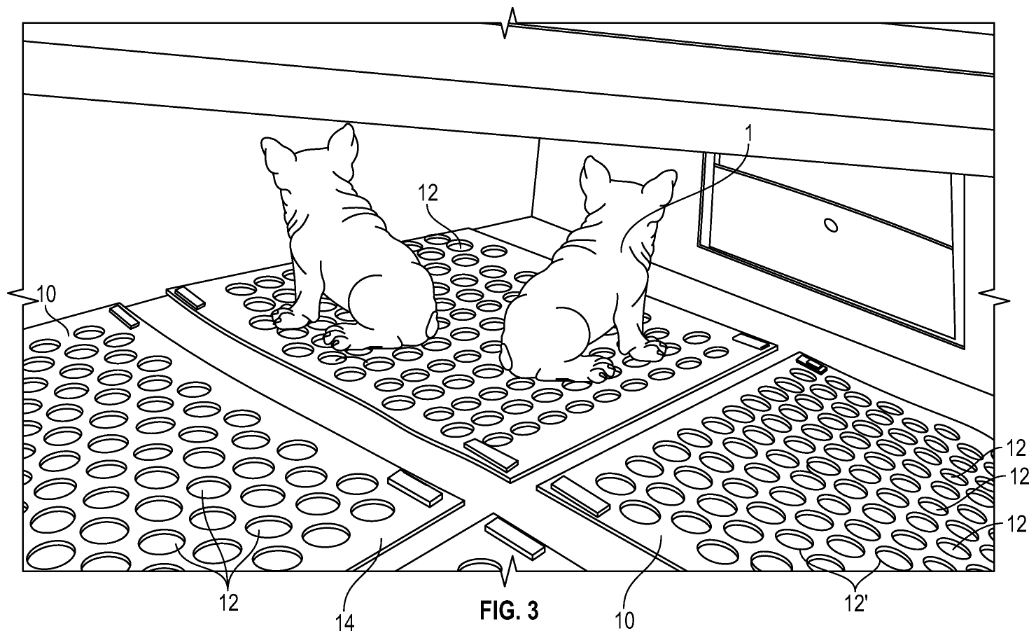

Turning to a first embodiment seen in FIGS. 2 and 3, the traction mat 10 of the current invention is laid out or placed on the bottom surface of a kennel, crate, or whelping box. The traction mat 10 is preferably comprised of non-toxic rubber such as silicone, however other materials including but not limited to plastic, plastic composites, or other types of rubber such as neoprene or polyurethane may be used without departing from the spirit and scope of the invention so long as the material is relatively flexible yet cannot be easily deformed or stretched, for example having a Shore A durometer measurement up to 85A. The upper surface of the traction mat 10 is smooth in order to make wiping and cleaning easy. Alternatively, the traction mat 10 may be removed from the whelping box so that it can be washed in water and soap and/or disinfectant. The traction mat 10 does not comprise any hard or sharp “edges” or surfaces and instead comprises rounded, curved, or otherwise softened borders or boundaries.

The traction mat 10 as seen in FIGS. 2-4 comprises a plurality of cavities or holes 12 that are symmetrically defined throughout the surface of the traction mat 10. Each hole 12 provides a circular or continuous inner vertical surface 12′ or side that a puppy 1 can push against with their pads and/or nails. In FIG. 2, the highlighted puppy 1 can be seen pressing the paw of their left hind leg squarely against the inner circumference or surface 12′ of one of the plurality of holes 12, thereby gaining or maintaining traction as they make their way across the traction mat 10. In FIG. 3, the same puppy 1 can be seen walking further across the traction mat 10, specifically with the paw or foot of their right hind leg pressing against the inner portion of a first hole of the plurality of holes 12 while the paw or foot of their right fore leg presses against or in a second hole of the plurality of holes 12.

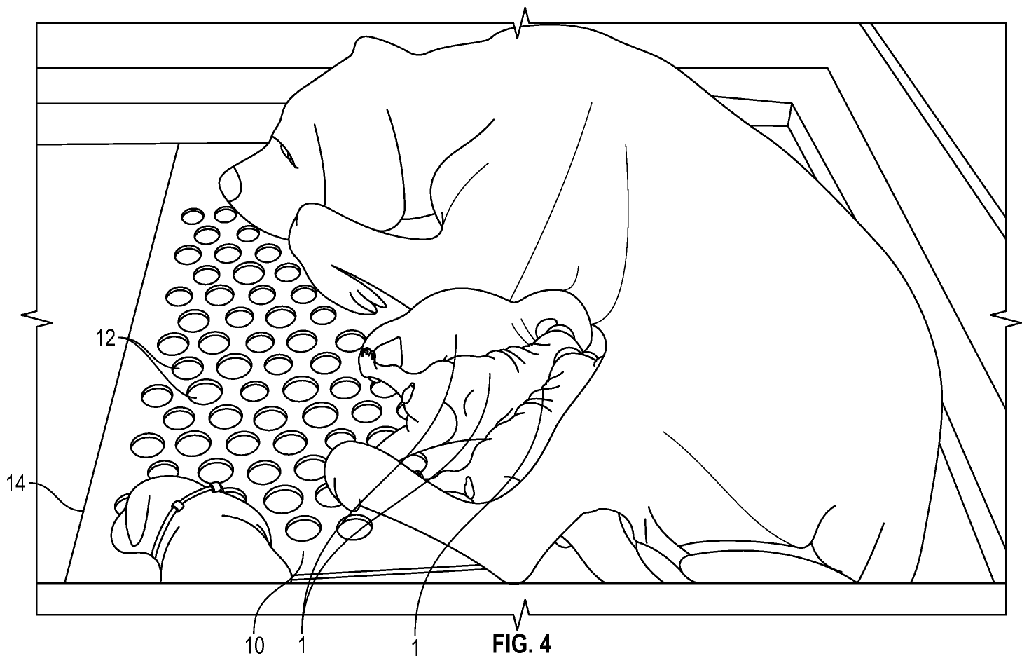

In FIG. 4, it can be seen that a plurality of puppies 1 may use in the same traction mat 10 simultaneously, with each paw of each respective puppy 1 pushing against the inner vertical surface 12′ of a different one of the plurality of holes 12.

In order to be effective, the diameter of each hole 12 must be larger than the diameter or length of the foot of the puppy 1, preferably by approximately 50%. The diameter of each hole 12 preferably ranges from 10 mm to 80 mm, however it is possible that the diameter may comprise a larger diameter if needed. The specific thickness of the traction mat 10 and the diameter of each of the holes 12 preferably follows the equation:

$${F}_{x} \times 0.5 \geq T \geq {F}_{x} \times 0.2$$

where Fₓ is the width of the back foot of the puppy at age x, and where T is the thickness of the traction mat 10. The thickness of the traction mat 10 will usually vary from ⅛″ for the smallest, lightest puppies, to ¼″ for puppies that are larger at birth or in week two.

The thickness or height of the traction mat 10 in turn determines the height of the inner vertical wall or surface 12′ for the puppy 1 to push against. If the traction mat 10 is not thick enough, the foot of the puppy 1 will slide out of the hole 12 when the puppy 1 pushes against the inner vertical surface 12′ of a hole 12. In such cases, the thickness of the traction mat 10 should be increased.

The plurality of holes 12 are specifically symmetrically defined across the horizontal surface area of the traction mat 10 so as to be spaced or disposed close enough so that a puppy 1 will encounter at least one hole 12 within a relatively short distance as it pushes its way across the traction mat 10, preferably within a distance that is less than the length of the leg of a puppy 1 when fully extended. However, the plurality of holes 12 are also defined in the traction mat 10 so as to avoid producing any hard “edges” or portions which may be uncomfortable for the puppy 1 or otherwise provide inadequate support for the body of the puppy 1. As seen in FIGS. 2 and 3, the placement or position of the plurality of holes 12 are spread symmetrically over the entire mat except for a strip or border disposed around the traction mat 10 in order to provide a continuous “frame” 14. The frame 14 is large enough so as to increase the overall strength or integrity of the traction mat 10, but is not so wide so that a puppy 1 may slip when moving across it. In a preferred embodiment, the frame 14 is within the range of ½ inch to 1½ inches. In an alternative embodiment, the traction mat 10 may be manufactured so that the plurality of holes 12 are defined all the way to the edge or end of the traction mat 10, thereby eliminating any surface or zone within the traction mat 10 which may be slippery.

The plurality of holes 12 defined within the traction mat 10 are preferably round or circular, however any other shape such a hexagon, oval, or oblong which that provides a vertical surface for a foot press against from any direction may be used without departing from the original spirit and scope of the invention. The inside vertical surface or wall 12′ of each of the plurality of holes 12 is smooth so it is easy to clean and maintain.

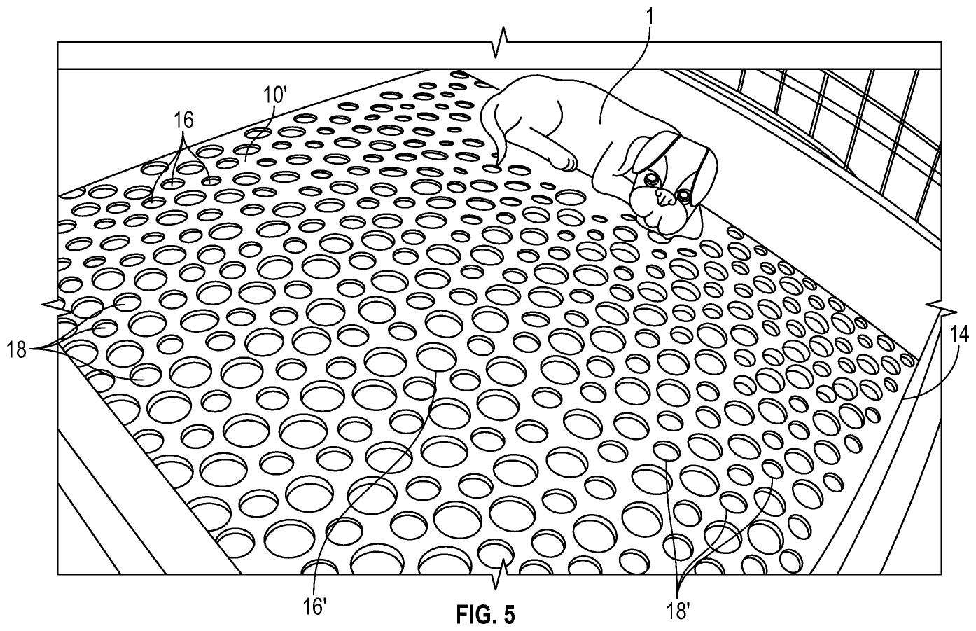

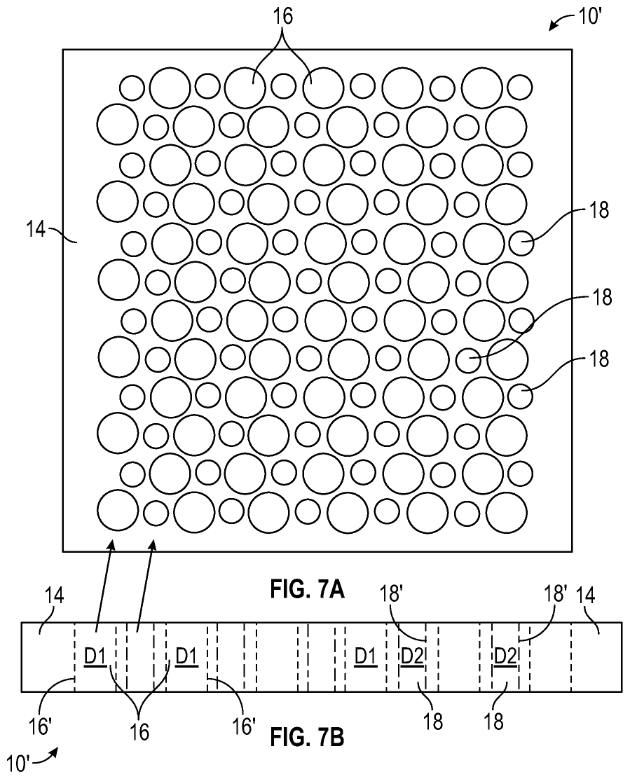

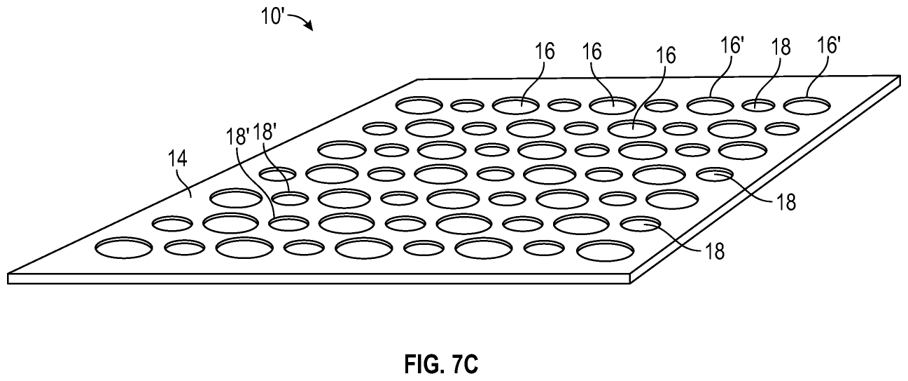

In another embodiment, the traction mat 10′ may comprise a plurality of holes of multiple different sizes to accommodate the growth of the foot. Turning to FIG. 5 and FIGS. 7A-7C, an alternative embodiment of the traction mat 10′ may be seen which comprises at least two different pluralities of holes, specifically a plurality of primary holes 16 and a plurality of secondary holes 18. The plurality of primary holes 16 and the plurality of secondary holes 18 are symmetrically defined throughout the traction mat 10′ so as to form a symmetrical pattern or matrix wherein the plurality of primary holes 16 and the plurality of secondary holes 16 are intermingled or defined amongst each other. As best seen in the cross-sectional view of FIG. 7B, each of the plurality of primary holes 16 comprises a first diameter D₁, while each of the plurality of secondary holes 18 comprises a second diameter D₂, wherein D₁ is larger than D₂. Additionally, it can be seen that each of the plurality of primary holes 16 comprise an inner vertical wall or surface 16′, while each of the plurality of secondary holes 18 comprise a corresponding inner vertical wall or surface 18′.

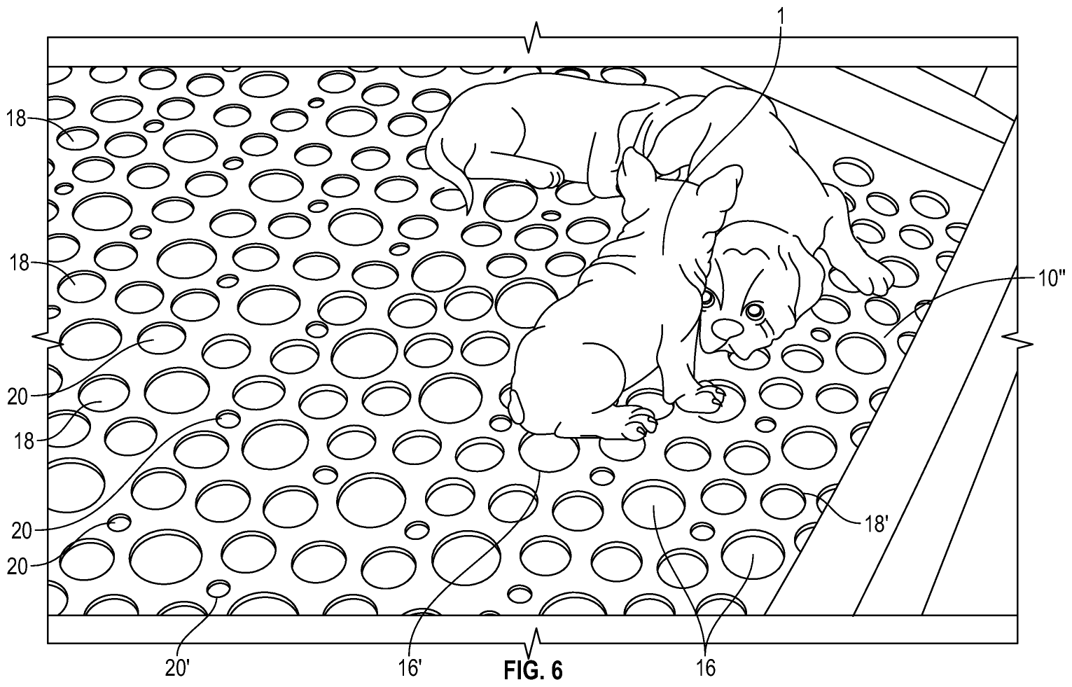

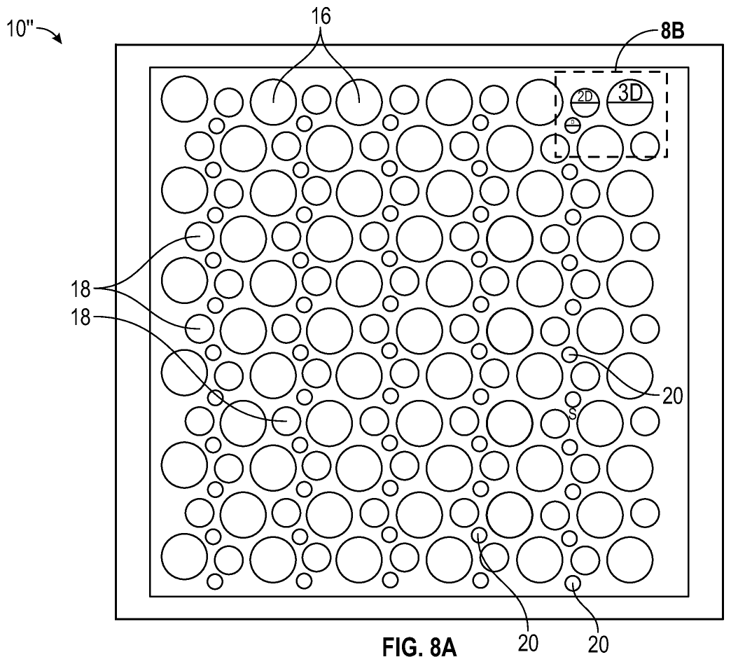

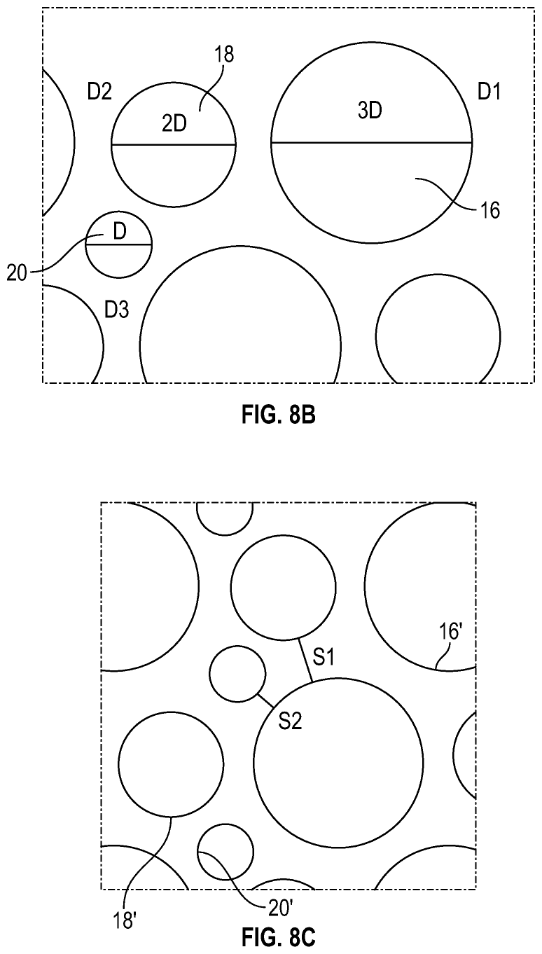

In an alternative embodiment seen FIGS. 6 and 8A-8C, the traction mat 10″ comprises three sets of differently sized holes. Specifically in this embodiment the traction mat 10″ comprises a plurality of primary holes 16, a plurality of secondary holes 18, and a plurality of tertiary holes 20. Like the plurality of primary holes 16 and secondary holes 16 discussed above, each of the plurality of tertiary holes 20 likewise comprise an inner vertical wall or surface 20′ as seen in FIG. 8C. The plurality of primary holes 16, secondary holes 18, and tertiary holes 20 are symmetrically defined throughout the traction mat 10″ so as to form a symmetrical pattern or matrix wherein the plurality of primary holes 16, secondary holes 16, and tertiary holes 20 are intermingled or defined amongst each other. Because the traction mat 10″ has holes of multiple sizes, it is able to accommodate the growth of the foot of the canine. The different pluralities of holes 16, 18, 20 can be defined in an alternating matrix, with the plurality of tertiary holes 20 sized according to back foot size of newly born puppies, and the larger plurality of secondary holes 18 sized to accommodate maximum foot size at 5-7 days old. As best seen in the magnified view of FIG. 8B, each of the plurality of primary holes 16 comprises a first diameter D₁, each of the plurality of secondary holes 18 comprises a second diameter D₂, and each of the plurality of tertiary holes 20 comprises a third diameter D₃. As seen in FIG. 8B, D₁ is larger than D₂, while D₂ in turn is larger than D₃. In this embodiment, the length or size of D₃ is keyed or dictated by the equation D₃=F×1.75, where F is the width of the canine's back foot or paw on day 0. The size or length of both D₂ and D₁ are directly dependent on D₃, namely with D₂ being twice the size of D₃, while D₁ is in turn three times the size of D₃. Furthermore, the specific spacing S between each of the plurality of primary holes 16, secondary holes 18, and tertiary holes 20 may be specifically defined by the equation S≤L×0.75, where L is the length of the rear leg of the canine. In other words, no two holes 16, 18, 20 defined within the traction mat 10″ are more than 75% of the length of the canine's rear leg apart from each other.

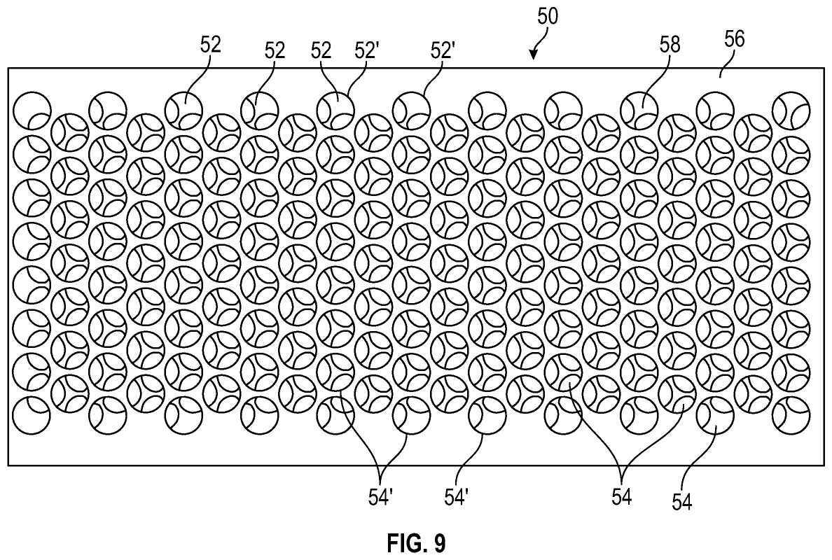

In a further embodiment seen in FIG. 9, the traction mat 50 comprises multiple layers or levels, with each layer or level comprising a different plurality of holes defined therein. For example, as seen in FIG. 9, the multi-layered traction mat 50 of the current embodiment comprises a first layer 56 disposed over or on top of a second layer 58 directly beneath it. The first layer 56 comprises a plurality of upper holes 52 which are symmetrically defined across the surface and through the thickness of the first layer 56, each of the upper holes 52 in turn comprising an inner vertical surface or wall 52′. Similarly, the second layer 58 comprises a plurality of lower holes 54 which are defined through the thickness of the second layer 58 in a symmetrical pattern across its surface. Each of the lower holes 54 comprise a corresponding inner vertical surface or wall 54′. In FIG. 9, the upper holes 52 are seen as being substantially circular in shape while the lower holes 54 are seen as being substantially oval, oblong, or egg shaped, however this is meant to be for illustrative purposes only as other shapes or configurations may be used without departing from the original spirit and scope of the invention. The lower holes 54 of the second layer 58 comprise a smaller diameter relative to the upper holes 52 so that multiple lower holes 54 may be exposed within the diameter of a singe upper hole 52. The multiple-layered configuration of the mat 50 allows for a single mat to be used as puppies continue to grow and develop. Specifically, when a puppy is only a few weeks old, their foot will be too small for the upper holes 52 and will instead fall through them until making contact with the second layer 58 and the inner surfaces 54′ of the lower holes 54 defined therein. The puppy may traverse the mat 50 in such a manner until their foot and legs grow enough to then allow them to push off or against the inner surfaces 52′ of the upper holes 52 instead. Alternatively, multiple puppies of different ages, sizes, or breeds may be contained within the same whelping box using the multi-layered mat 50, namely with the smaller or younger puppies using the lower holes 54, and the larger or older puppies using the upper holes 52.

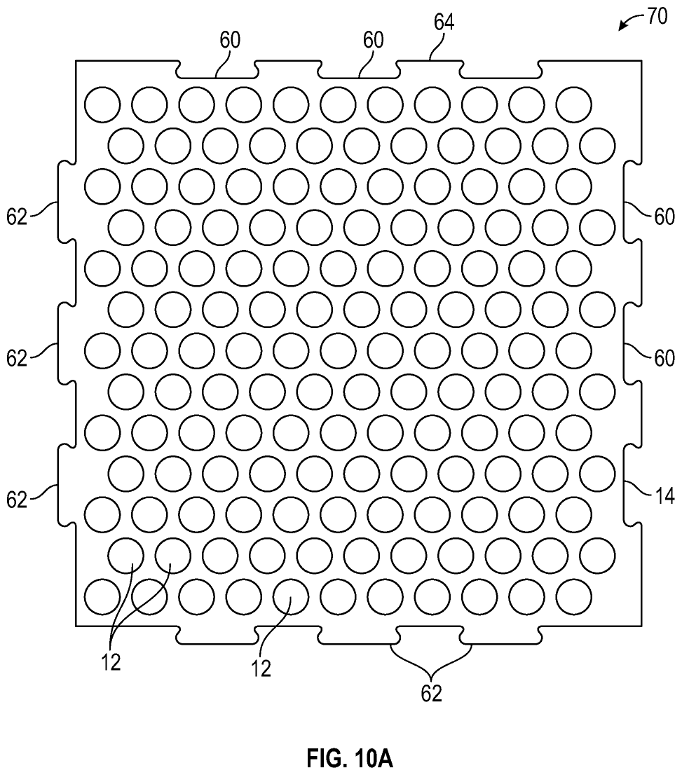

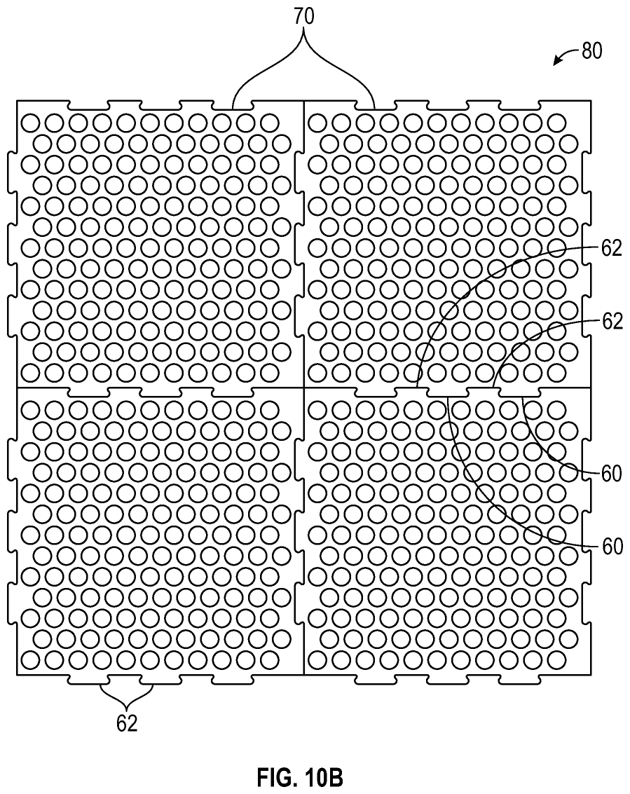

In yet a further embodiment seen in FIGS. 10A and 10B, the traction mat 70 comprises a means for interlocking to one or more other traction mats 70 in order to form one, larger uniform traction pad 80. As best seen in FIG. 10A, each traction mat 70 comprises a plurality of female blanks or locks 60 defined along at least one edge of the traction mat 70 and a corresponding plurality of male tabs or keys 62 disposed along at least one opposing edge of the traction mat 70. For example, the top longitudinal edge of the traction mat 70 seen in FIG. 10A comprises a plurality of female blanks 60 defined therein while the bottom longitudinal edge of the traction mat 70 comprises in turn a plurality of male tabs 62. Similarly, the right lateral edge of the traction mat 70 comprises a plurality of female blanks 60 defined therein while the left lateral edge of the traction mat 70 comprises in turn a plurality of male tabs 62. As with the prior embodiments discussed above, the traction mat 70 further comprises a plurality of holes 12 defined through its thickness and a frame 14 that is disposed around the plurality of holes 12, however in a preferred embodiment the frame 14 is as narrow as possible so the plurality of holes 12 are substantially evenly spaced across the surface of the traction mat 70, even to the edges.

The plurality of female blanks 60 and the plurality of male tabs 62 are sized and shaped to be the mirror image inverses of each other so that when the male tabs 62 disposed on a first traction mat 70 are placed or inserted into the female blanks 60 of a second traction mat 70, a tight snap or friction fit is formed therebetween so as to couple or join the first and second traction mats 70 together. In this fashion, a user may couple multiple traction mats 70 together in order to form a larger traction pad 80, with each traction mat 70 accommodating or being coupled up to four other adjacent traction mats 70. While FIG. 10B shows a traction pad 80 formed by four traction mats 70 coupled together along two edges or sides of each traction mat 70, this is meant to be illustrative purposes only. Additional, fewer, or alternatively shaped traction mats 70 from what is explicitly seen may be coupled in a multitude of configurations so as to form a traction pad 80 that is almost any desired shape. In other words, a user may couple a plurality of traction mats 70 together in order to form a traction pad 80 which best fits their specific or unique kennel, whelping box, or other containment area.

The traction mat 10 may also form part of a kit, namely a kit which comprises a plurality of different traction mats 10. For example, in one embodiment, the kit may comprise three traction mats 10, each traction mat 10, comprising a different set of size specifications including but not limited to the thickness or height of the traction mat 10, the size or diameter of the plurality of holes 12, and the relative spacing or distribution of the plurality of holes 12 defined throughout the traction mat 10. A user using the kit can then adjust the traction mat 10 disposed within the whelping box depending on the breed, size, and age of the puppy. For example, if the puppy 1 to use the traction mat 10 is extremely young, a traction mat 10 comprising holes 12 which are closely distributed together may be used. As the puppy 1 ages and becomes bigger, the first traction mat 10 may be replaced with a second traction mat 10 which has its corresponding holes 12 further spread or spaced apart from each other. Finally, a third traction mat 10 may be used when the puppy 1 grows even larger, the third traction mat 10 comprising a plurality of holes 12 which are still further spaced apart from each other relative to any other traction mats 10 included within the kit.

The diameter of each of the plurality of holes 12 and the thickness of each traction mat 10 within the kit may scaled or keyed to the size and/or breed of a puppy at a particular age. Additionally, the overall size or surface area of the traction mat 10 may be scaled or keyed to accommodate a specific litter size, puppy size, or the specific dimensions and arrangement of the whelping box. For example, in a traction mat 10 keyed to canines who are one week old, the overall size of the traction mat 10 should provide adequate space for a plurality of puppies 1 to nurse, i.e., access to the nursing mother canine as seen in FIG. 4. Additional traction mats 10 that are keyed for puppies that are older than one week have a corresponding size which is adequate to allow for some movement, but still small enough so to keep puppies close to the nursing mother canine or together in a restricted area, until they are able to regulate their body temperature.

In one specific example for a canine of a medium-sized breed (e.g., 40-60 pounds as an adult), a kit may comprise two different traction mats 10, each mat 10 being dedicated or keyed for the first and second week of the canine's life, respectively. The “week 1” traction mat 10 may comprise a thickness of approximately ⅜″, a minimum hole diameter of about 10 mm, a minimum distance between holes of about 5 mm, and a maximum distance between holes of about 10 mm. At the start of the second week, the user replaces the “week 1” traction mat 10 with a “week 2” traction mat 10, the “week 2” traction mat comprising a thickness of approximately ¼″, a larger minimum hole diameter, a minimum distance between holes of about 5 mm, and a maximum distance between holes of about 10 mm.

When the traction mat 10 is placed into a whelping box, kennel, or pen, it must be placed on a solid surface so there is no space between the traction mat 10 and a surface disposed beneath where a leg of a puppy 1 could get caught. The traction mat 10 should not be placed on “fleece” or layers of towels or other material that is compressible and thus could produce or create a space under the traction mat 10 and possibly trap a leg or other part of the puppy 1. Preferably, the material under the mat should also be absorbent for liquids.

While the above description is directed to young canines or puppies and the prevention of CHD, it is to be expressly understood that the current invention may be used for a variety of different types of animals and could be used to treat or prevent a variety of different conditions or maladies. For example, the traction mat 10 mat may be used to treat a number of different animals including but not limited to cats, rabbits, pigs, birds, and even captive wildlife (e.g., breeding zoo animals). Additionally, the current invention may be used to treat multiple disorders/health issues caused by inadequate traction in a whelping box. For example, beyond just reduction in hip dysplasia, conditions such as patellar luxation, “swimmer” puppy, flat chests in puppies, and even neurological disorders may be addressed by the traction mat 10. It is to be further understood that other types of animals and types of treatable conditions not explicitly recited herein are expressly contemplated as being within the current spirit and scope of the current invention.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A traction mat for preventing or treating developmental disorders in an animal comprising:
a first surface; and
a plurality of holes symmetrically defined across the first surface,
where each of the plurality of holes comprise a continuous smooth inner vertical wall defined through a height of the traction mat.

2. The traction mat of claim 1 where the plurality of holes symmetrically defined across the first surface comprises:
a first plurality of holes comprising a first diameter symmetrically defined across the first surface; and
a second plurality of holes comprising a second diameter symmetrically defined across the first surface,
where the first diameter of the first plurality of holes is larger than the second diameter of the second plurality of holes.

3. The traction mat of claim 1 where the plurality of holes symmetrically defined across the first surface comprises:
a first plurality of holes comprising a first diameter symmetrically defined across the first surface;
a second plurality of holes comprising a second diameter symmetrically defined across the first surface; and
a third plurality of holes comprising a third diameter symmetrically defined across the first surface,
where the second diameter of the second plurality of holes is smaller than the first diameter of the first plurality of holes but larger than the third diameter of the third plurality of holes.

4. The traction mat of claim 3 where the first diameter of the first plurality of holes is at least three times larger than the third diameter of the third plurality of holes.

5. The traction mat of claim 3 where the second diameter of the second plurality of holes is at least two times larger than the third diameter of the third plurality of holes.

6. The traction mat of claim 1 further comprising:
a plurality of female blanks defined along at least one edge of the first surface; and
a plurality of male tabs disposed along at least one edge of the first surface,
where each of the plurality of female blanks are configured to accommodate at least one of the plurality of male tabs.

7. The traction mat of claim 1 further comprising:
a second surface; and
a plurality of holes symmetrically defined across the second surface,
where each of the plurality of holes defined across the second surface comprise a continuous smooth inner vertical wall defined through at least a portion of the height of the traction mat.

8. The traction mat of claim 7 where at least one of the plurality of holes defined across the second surface is disposed within at least one of the plurality of holes defined across the first surface.

9. A kit for preventing or treating developmental disorders in an animal comprising:
a first traction mat as claimed in claim 1; and
a second traction mat,
where both the first traction mat and the second traction mat each comprise a plurality of holes defined through their respective surfaces.

10. The kit of claim 9 where the first traction mat comprises a thickness that is different relative to a thickness of the second traction mat.

11. The kit of claim 9 where the plurality of holes defined through the surface of the first traction mat comprise a diameter which is different relative to a diameter of the plurality of holes defined through the surface of the second traction mat.

12. The kit of claim 9 where the plurality of holes defined through the surface of the first traction mat are disposed in a pattern across the surface of the first traction mat which is different relative to the plurality of holes defined through the surface of the second traction mat.

13. The kit of claim 9 further comprising a third traction mat, where the third traction mat comprises a plurality of holes defined through its respective surface.

14. A method of manufacturing a traction mat as claimed in claim 1 for an animal comprising:
providing the traction mat with a thickness; and
defining a plurality of holes through the thickness of the traction mat, where each of the plurality of holes comprises a diameter,
where the thickness of the traction mat and the diameter of each of the plurality holes are dependent upon a width of a foot of the animal.

15. The method of claim 14 where providing the traction mat with a thickness comprises providing the traction mat with a thickness which is between 20% and 50% the width of the foot of the animal.

16. The method of claim 14 where defining the plurality of holes through the thickness of the traction mat further comprises providing a continuous smooth inner surface within the traction mat for each of the plurality of holes.

17. The method of claim 14 where defining the plurality of holes through the thickness of the traction mat further comprises determining a spacing between each of the plurality of holes defined through the thickness of the traction mat which is dependent upon a length of a leg of the animal.

18. The method of claim 17 where determining the spacing between each of the plurality of holes defined through the thickness of the traction mat which is dependent upon a length of a leg of the animal comprises defining each of the plurality of holes at a distance not more than 75% of the length of the leg of the animal from any other of the plurality of holes.

19. The method of claim 14 where defining the plurality of holes through the thickness of the traction mat comprises:
defining a first plurality of holes through the thickness of the traction mat with a first diameter;
defining a second plurality of holes through the thickness of the traction mat with a second diameter; and
defining a third plurality of holes through the thickness of the traction mat with a third diameter,
where the first diameter, second diameter, and third diameter are dependent upon the width of the foot of the animal.

20. The method of claim 19 where the first diameter is at most 75% longer than a length of a leg of the animal, where the second diameter is at least two times as long as the first diameter, and where the third diameter is at least three times as long as the first diameter.
